(19) United States
(12) Patent Application Publication
(10) Pub. No.: US 2011/0030961 A1
(43) Pub. Date: Feb. 10, 2011

(54) Treatment of Fluids that Increase in Viscosity at or Above a Threshold Temperature and Methods of Formulating and Using Such Fluids

(76) Inventor: Jason E. Maxey, Spring, TX (US)

Correspondence Address: Stephen A. Littlefield;Baker Hughes Incorporated, P.O. Box 4740, Houston, TX, 77210-4740, US

(21) Appl. No.: 12/742,184

(22) PCT Filed: Nov. 12, 2008
(86) PCT No.: PCT/US08/83195

§ 371 Date: Oct. 19, 2010

Related U.S. Application Data
(60) Provisional application No. 60/989,540, filed on Nov. 21, 2007.

(51) Int. Cl. E21B 43/00; C09K 8/588

(52) U.S. Cl. 166/310; 507/211

(57) ABSTRACT

A treatment fluid comprising: aqueous base comprising a combination of components effective to viscosify the treatment fluid upon exposure to a temperature at or above a threshold temperature, the treatment fluid having a pH of greater than 7; the combination of components comprising: a concentration of oil emulsified in the aqueous base; a quantity of water soluble polymer comprising one or more polysaccharides having a weight average molecular weight of about 500,000 to about 2,500,000; and, an amount of surfactant.

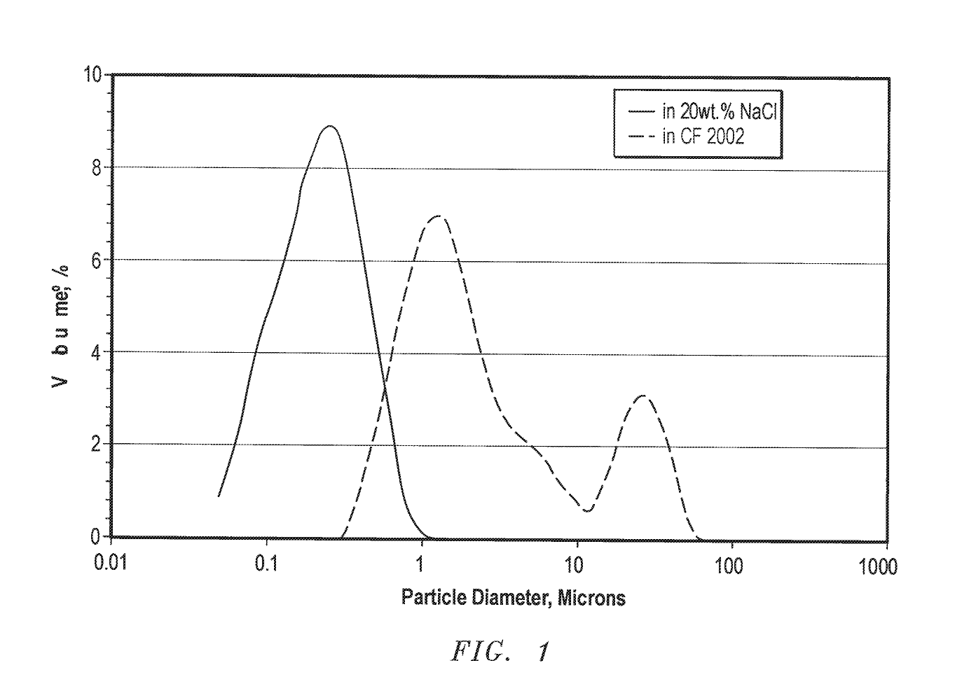

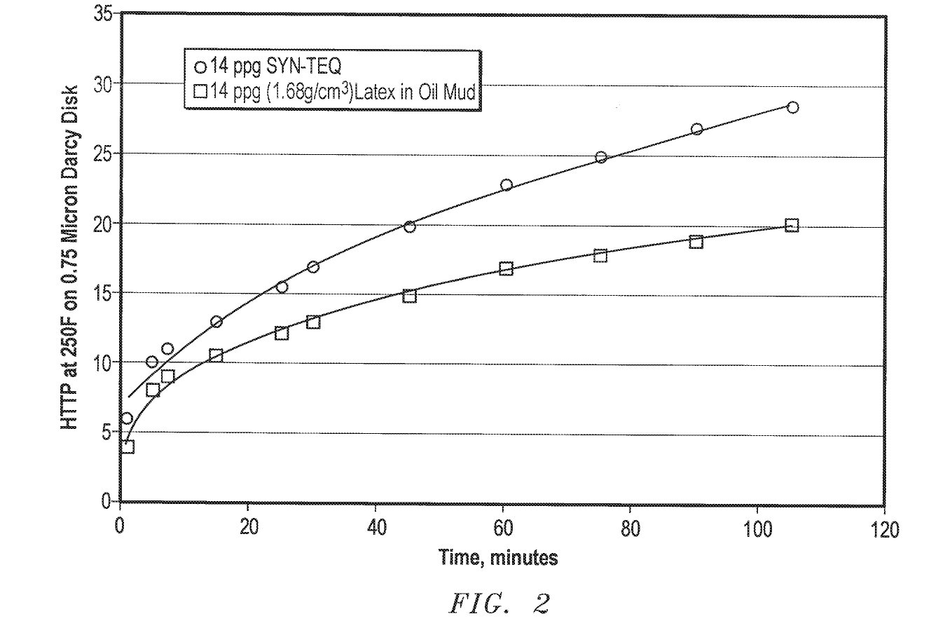

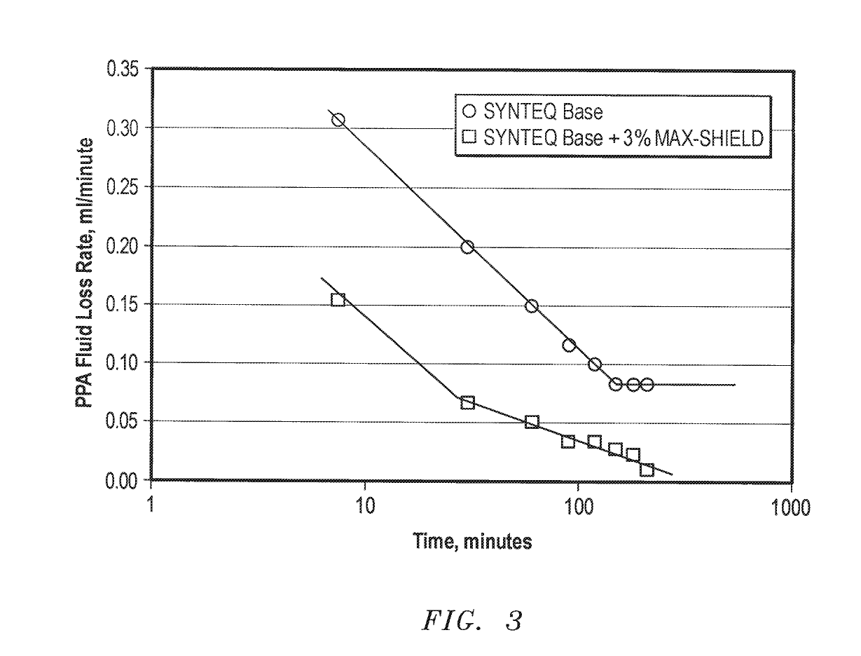

### FIELD OF THE APPLICATION

The present application provides treatment fluids that increase in viscosity upon exposure to at or above a threshold temperature and to methods of formulating and using same.

### BACKGROUND

During petroleum recovery operations, the viscosity of most fluid systems tends to decrease when exposed to increased temperatures. In some circumstances, however, it is advantageous for the viscosity of a fluid system to remain relatively constant, or to increase upon exposure to increased temperatures.

### SUMMARY OF THE INVENTION

The present application provides aqueous base treatment fluids that increase in viscosity upon exposure to temperatures at or above a threshold level, and to methods of formulating and using such fluids.

In one embodiment, the application provides a treatment fluid comprising: aqueous base comprising a combination of components effective to viscosify the treatment fluid upon exposure to a temperature at or above a threshold temperature, the treatment fluid having a pH of greater than 7; the combination of components comprising: a concentration of oil emulsified in the aqueous base; a quantity of water soluble polymer comprising one or more polysaccharides having a weight average molecular weight of about 500,000 to about 2,500,000; and, an amount of surfactant.

In one embodiment, the application provides a treatment fluid comprising: aqueous base comprising a combination of components effective to viscosify the treatment fluid upon exposure to at or above a threshold temperature, the treatment fluid having a pH of greater than 7; the combination of components comprising: from about 2 vol. % to about 7 vol. % oil emulsified in the aqueous base; a quantity of water soluble polymer comprising one or more modified polysaccharides having a weight average molecular weight of about 500,000 to about 2,500,000; and, from about 0.5 vol. % to about 3 vol. % surfactant.

In one embodiment, the application provides a treatment fluid comprising: aqueous base comprising a combination of components effective to viscosify the treatment fluid upon exposure to a temperature at or above a threshold temperature, the treatment fluid having a pH of greater than 7; the combination of components comprising: from about 2 vol. % to about 7 vol. % paraffins emulsified in the aqueous base; a quantity of water soluble polymer comprising modified polysaccharides having a weight average molecular weight of about 500,000 to about 2,500,000; and, from about 0.5 vol. % to about 3 vol. % surfactant.

In one embodiment, the application provides a method of formulating an aqueous base treatment fluid comprising: mixing an aqueous base with an amount of surfactant and a quantity of water soluble polymer comprising one or more polysaccharides having a weight average molecular weight of about 500,000 to about 2,500,000 under conditions effective to hydrate and disperse the polysaccharides in the aqueous base; emulsifying a concentration of oil in the aqueous base, producing an oil-in-water emulsion; and, adjusting the threshold temperature of the oil-in-water emulsion by adjusting one or more of the pH, the concentration of oil, and the concentration of surfactant, thereby producing a treatment fluid having a predetermined threshold temperature.

In one embodiment, the application provides a method of treating a subterranean formation, the method comprising: measuring a threshold temperature at a location in the subterranean formation having an initial permeability; and, transporting to the location an aqueous base treatment fluid having a pH of greater than 7 which increases in viscosity upon exposure to temperatures at or above the threshold temperature, the treatment fluid comprising a quantity of one or more polysaccharides, a concentration of oil emulsified in the aqueous base, and an amount of surfactant, the quantity, the concentration, and the amount being effective to produce an increased viscosity aqueous base treatment fluid and to reduce the initial permeability at the location.

### DETAILED DESCRIPTION OF THE INVENTION

The present application provides aqueous base treatment fluids that increase in viscosity upon exposure to temperatures at or above a “threshold temperature.”

The “threshold temperature” is the temperature at or above which a given aqueous base treatment fluid viscosifies. In one embodiment, the threshold temperature is equivalent to the minimum temperature expected downhole during petroleum recovery operations.

In one embodiment, the aqueous base treatment fluid has a threshold temperature which varies depending upon actual temperatures to be encountered during petroleum recovery operations. In this embodiment, the formation temperature is measured, and the aqueous base treatment fluid is formulated to have a “threshold temperature,” which is substantially the same as the formation temperature.

### Viscosity of the Aqueous Base Treatment Fluid

Upon exposure to at or above the threshold temperature, the viscosity of the aqueous base treatment fluid increases. The viscosity of a fluid is its internal resistance to flow. The coefficient of viscosity of a normal homogeneous fluid at a given temperature and pressure is a constant for that fluid and independent of the rate of shear or the velocity gradient. Fluids that obey this rule are “Newtonian” fluids. In fluids called “non-Newtonian fluids,” this coefficient is not constant but is a function of the rate at which the fluid is sheared as well as of the relative concentration of the phases.

The aqueous base treatment fluids of the present application generally are non-Newtonian fluids. Non-Newtonian fluids frequently exhibit plastic flow, in which the flowing behavior of the material occurs after the applied stress reaches a critical value or yield point (YP). The yield point of a fluid used during petroleum recovery operations frequently is expressed in units of Newtons per square meter (N/m²), Pascal (Pa), or pounds per 100 square feet² (lb/100 ft²). The yield point is a function of the internal structure of a fluid.

During petroleum recovery operations, once the critical value or yield point (YP) of the drilling fluid is achieved, the rate of flow or rate of shear typically increases with an increase in pressure, causing flow or shearing stress. The rate of flow change, known as plastic viscosity (PV), is analogous to viscosity in Newtonian fluids. In fracturing fluids and drilling fluids, yield points (YP) above a minimum value are desirable to adequately suspend solids, such as weighting agents, cuttings, and/or proppant.

In the laboratory, an aqueous base treatment fluid has an initial YP before aging and an initial PV before aging. Whether or not the aqueous base treatment fluid will increase in viscosity upon exposure to a threshold temperature can be assessed in the laboratory by aging the treatment fluid at a temperature at or above the threshold temperature. Generally, reference to “aging” or to an “aged” treatment fluid means that the treatment fluid was hot rolled for a period of about 12 hours or more.

The conditions of aging may vary depending upon the composition of the treatment fluid and expected temperatures to be encountered during the petroleum recovery operations. For example, where the aqueous base is brine, the brine may comprise organic salt, inorganic salt, or a combination thereof. Where the salt is organic salt, aging at a temperature of 37.8° C. (100° F.) or more in the laboratory generally is predictive of the increase in viscosity that can be expected downhole upon exposure to at or above the threshold temperature. Where the salt in the brine is inorganic salt, aging at a temperature of 66° C. (150° F.) or more in the laboratory generally is predictive of the increase in viscosity that can be expected downhole upon exposure to at or above the threshold temperature.

An aged treatment fluid has a final YP and a final PV. If the final YP is greater than the initial YP and/or if the final PV is greater than the initial PV, then the treatment fluid is expected to increase in viscosity when exposed to at or above the threshold temperature downhole. In one embodiment, the final YP of a treatment fluid after aging is greater than the initial YP of the treatment fluid. In one embodiment, the final PV of a treatment fluid after aging is greater than the initial PV of the treatment fluid. In one embodiment, both the final YP and the final PV of a treatment fluid after aging are greater than the initial YP and the initial PV of the treatment fluid, respectively.

The initial and final PV and YP of the aqueous base treatment fluid may be measured using any suitable viscometer. at any temperature. In one embodiment, the initial and final PV and the YP are measured using a FANN 35 viscometer at 24° C. (75° F.).

The application encompasses an aqueous base treatment fluid if it exhibits any increase in YP after aging. In one embodiment, the final YP of the aqueous base treatment fluid is about 30% or more greater than the initial YP after aging. In one embodiment, the final YP of the aqueous base treatment fluid is about 50% or more greater than the initial YP after aging. In one embodiment, the final YP of the aqueous base treatment fluid is about 100% or more greater than the initial YP after aging. In one embodiment, the aqueous base treatment fluid has a final YP after aging which is about 9.6 Pa (20 lb/100 ft²) or more. In one embodiment, the aqueous base treatment fluid has a final YP after aging which is about 16.8 Pa (35 lb/100 ft²) or less.

The aqueous base treatment fluid also exhibits an initial plastic viscosity (PV) and a final PV after aging. In one embodiment, the final PV is greater than the initial PV. In one embodiment, the final PV is about 20% or more greater than the initial PV. In one embodiment, the final PV is about 30% or more greater than the initial PV. In one embodiment, the final PV is about 35% or more greater than the initial PV. In one embodiment, the final PV is about 40% or more greater than the initial PV.

The pH of the treatment fluid is sufficiently high to cause the treatment fluid to increase in viscosity upon exposure to at or above the threshold temperature. In one embodiment, the treatment fluid has a pH of greater than 7. In one embodiment, the treatment fluid has a pH of about 8 or more. In one embodiment, the treatment fluid has a pH of about 11 or less. In one embodiment, the treatment fluid has a pH of about 10.5 or less. In one embodiment, the treatment fluid has a pH of about 10 or less. In one embodiment, the treatment fluid has a pH of about 9 or less.

The treatment fluid generally has a density of from about 1 kg/m³ (8.5 lb./gal.) or more. In one embodiment, the treatment fluid has a density of about 1.2 kg/m³ (10 lb./gal.) or more. In one embodiment, the treatment fluid exhibits low shear rate viscosity (LSRV), which resists fluid movement into the formation zone and inhibits lost circulation.

The aqueous base treatment fluid may be used in a variety of applications. In one embodiment, the aqueous base treatment fluid is used during petroleum recovery operations. In one embodiment, the aqueous base treatment fluid is used as a fracturing fluid, a drilling fluid, or a lost circulation fluid.

In one embodiment, the treatment fluid meets relevant environmental standards at the location of the petroleum recovery. In one embodiment, the treatment fluid meets the applicable EPA requirements for discharge into U.S. waters. Currently, a drilling fluid meets EPA requirements if it has an LC₅₀ of 30,000 parts per million (ppm) suspended particulate phase (SPP) or higher. The LC₅₀ is the concentration at which 50% of exposed 4-6 day old Mysidopsis bahia shrimp are killed.

### Composition of the Aqueous Base Treatment Fluid

In one embodiment, the aqueous base treatment fluid comprises an aqueous base, oil, water soluble polymer, and surfactant.

Aqueous Base

In one embodiment, the aqueous base is fresh water. In one embodiment, the aqueous base is a water base fluid. In one embodiment, the aqueous base is brine.

In one embodiment, the aqueous base comprises brine comprising about 10 g/l salt or more. In one embodiment, the aqueous base comprises brine comprising about 300 g/l salt or less.

Suitable brines comprise substantially any salt commonly used to formulate fluid systems for petroleum recovery operations. The salts may have any suitable valence. Suitable salts include, for example, calcium chloride, sodium chloride, potassium chloride, magnesium chloride, calcium bromide, sodium bromide, potassium bromide, calcium nitrate, sodium formate, potassium formate, cesium formate, and mixtures thereof. In one embodiment, the salt is one or more organic salt. In one embodiment, the salt is one or more inorganic salt. In one embodiment, the salt is a combination of one or more organic salt and one or more inorganic salt.

Where the aqueous base treatment fluid comprises brine, the threshold temperature may vary depending upon the type of salt found in the brine. In one embodiment, the salt is organic salt and the threshold temperature of the treatment fluid generally is from about 38° C. (100° F.) to about 49° C. (120° F.). In one embodiment, the salt is one or more inorganic salt, and the threshold temperature of the treatment fluid is higher. In one embodiment, the only type of salt in the brine is inorganic salt, and the threshold temperature is about 66° C. (150° F.) or more.

Oil

The oil may be substantially any organic fluid which is non-toxic and sufficiently biodegradable according to requirements at the location used. Suitable oils include, for example, paraffins, olefins, water insoluble polyglycols, water insoluble esters, diesel fuels, water insoluble Fischer-Tropsch reaction products, and combinations thereof. Examples of suitable olefins include, for example, polyalphaolefins, linear alpha olefins, and internal olefins, typically skeletally isomerized olefins.

In one embodiment, the oil comprises one or more paraffins. The use of paraffin has been found to reduce the quantity of oil required in the treatment fluid. Substantially any paraffin may be used. Suitable paraffins are described, for example, in U.S. Pat. No. 5,837,655, incorporated herein by reference. In one embodiment, the paraffin is SIPDRILL™, which is commercially available from SIP, Ltd, UK.

The amount of oil in the treatment fluid may vary depending upon the desired threshold temperature of the treatment fluid and the type of oil. In one embodiment, the amount of oil in the treatment fluid is about 0.5 vol. % or more. In one embodiment, the amount of oil in the treatment fluid is about 2 vol. % or more. In one embodiment, the amount of oil in the treatment fluid is about 15 vol. % or less. In one embodiment, the amount of oil in the treatment fluid is about 7 vol. % or less. As the amount of oil in the treatment fluid increases, the threshold temperature generally decreases.

Water Soluble Polymers

In one embodiment, the treatment fluid comprises one or more water soluble polymers effective to increase the viscosity of the treatment fluid upon exposure to at or above the threshold temperature. In one embodiment, the one or more water soluble polymers provide fluid loss control for the treatment fluid.

In one embodiment, the treatment fluid comprises one or more water soluble polysaccharides. Suitable water soluble polysaccharides include, for example, xanthan polysaccharides, wellan polysaccharides, scleroglucan polysaccharides, and guar polysaccharides. In one embodiment, the treatment fluid comprises xanthan polysaccharides.

In one embodiment, the treatment fluid comprises one or more modified polysaccharides. The modified polysaccharides may have any molecular weight that is effective to cause the treatment fluid to increase in viscosity upon exposure to at or above the threshold temperature. Suitable modified polysaccharides include, for example, those having a weight average molecular weight of about 500,000 to about 2,500,000. In one embodiment, the modified polysaccharides have a weight average molecular weight of about 700,000 to about 1,200,000. In one embodiment the modified polysaccharides have a weight average molecular weight of about 1,000,000. In one embodiment, the aqueous base treatment fluid comprises modified xanthan polysaccharides. In one embodiment, the synthetically modified polysaccharides comprise a functional group selected from the group consisting of a carboxymethyl group, a propylene glycol group, and an epichlorohydrin group. Suitable commercially available modified xanthan polysaccharides include, for example, XAN-PLEX™, XAN-PLEX D™, and XANVIS™, all of which are commercially available from Baker Hughes Drilling Fluids. In one embodiment, the aqueous base treatment fluid comprises XAN-PLEX™ D polysaccharides which are commercially available from Baker Hughes Drilling Fluids.

Where used herein, the term and “modified polysaccharides” or “synthetically modified polysaccharides” refers to polysaccharides that have been chemically modified in a manner that renders them inherently non-fermentable in order to avoid the need for a preservative. Suitable water-soluble “modified polysaccharides” include, for example: hydroxyalkyl polysaccharides; polysaccharide esters; cross-link polysaccharides; hypochlorite oxidized polysaccharides; polysaccharide phosphate monoesters; cationic polysaccharides; polysaccharide xanthates; and, polysaccharides. These modified polysaccharides can be manufactured using known means, such as those set forth in detail in Chapter X of Starch: Chemistry and Technology 311-388 (Roy L. Whistler, et al. eds., 1984), incorporated herein by reference.

Specific suitable modified polysaccharides include, for example: carboxymethyl polysaccharides; hydroxyethyl polysaccharides; hydroxypropyl polysaccharides; hydroxybutyl polysaccharides; carboxymethylhydroxyethyl polysaccharides; and, carboxymethylhydroxypropyl polysaccharides; carboxymethylhydroxybutyl polysaccharides; epichlorohydrin polysaccharides; alkylene glycol modified polysaccharides; and, other polysaccharide copolymers having similar characteristics. In one embodiment, the modified polysaccharides comprise a functional group selected from the group consisting of a carboxymethyl group, a propylene glycol group, and an epichlorohydrin group.

The treatment fluid also may comprise one or more additional water soluble polymers. Suitable additional water soluble polymers include, for example, polymers having a single monomer and polymers having multiple monomers. Suitable additional water-soluble polymers are non-toxic. Suitable additional water soluble polymers include, for example, water soluble starches and modified versions thereof, water soluble celluloses and modified versions thereof, water soluble polyacrylamides and copolymers thereof, and combinations thereof. Suitable additional water soluble polymers also include, for example, those having a weight average molecular weight of about 500,000 to about 2,500,000. In one embodiment, the additional water soluble polymers have a weight average molecular weight of about 700,000 to about 1,200,000. Suitable additional water soluble polymers also may be chemically modified as described above with respect to the polysaccharides to render them inherently non-fermentable in order to avoid the need for a preservative.

Suitable water soluble starches include, for example, corn based starches and potato based starches. Where water soluble starch is used, the starch typically is relatively temperature stable.

Suitable water soluble celluloses include, for example, hydrophobically modified hydroxyethyl celluloses and cationic cellulose ethers. Suitable copolymers of acrylamide include copolymers with acrylate monomers, hydrophobic N-isopropylacrylamide, and combinations thereof.

In one embodiment, the water soluble polymer is a blend comprising modified polysaccharides and synthetically modified starch. In one embodiment, the water soluble polymer is a blend comprising from about 10 wt. % to about 90 wt. % of one or more modified polysaccharides and from about 10 wt. % to about 90 wt. % of one or more synthetically modified starches. In one embodiment, the polymer is a blend comprising from about 10 to about 20 wt. % of one or more synthetically modified polysaccharides with the remainder of the blend being one or more synthetically modified starches. In one embodiment, the blend is from about 14 wt. % to about 15 wt. % of one or more modified polysaccharides, the remainder being one or more synthetically modified starches.

The synthetically modified starches may have any molecular weight that is effective to assist in increasing the viscosity of the treatment fluid upon exposure to at or above the threshold temperature. Suitable synthetically modified starches include, for example, those having a weight average molecular weight of from about 200,000 to about 2,500,000. In one embodiment, the synthetically modified starches have a weight average molecular weight of from about 600,000 to about 1,000,000. In one embodiment, the synthetically modified starches comprise a functional group selected from the group consisting of a carboxymethyl group, a propylene glycol group, and an epichlorohydrin group. Suitable synthetically modified starches include, but are not necessarily limited to BIOPAQ™, BIOLOSE™, and PERMALOSE™, which are commercially available from Baker Hughes Drilling Fluids.

In one embodiment, the aqueous base treatment fluid comprises an amount of water soluble polymer which is sufficient to increase the viscosity of the aqueous base treatment fluid when exposed to temperatures at or above a threshold temperature. In one embodiment, the total quantity of water soluble polymer is about 1 g/l (0.35 lb/bbl) or more, based on the total volume of the aqueous base treatment fluid. In one embodiment, the total quantity of water soluble polymer is about 20 g/l (7 lb/bbl) or more based on the total volume of the aqueous base treatment fluid. In one embodiment, the total quantity of water soluble polymer is about 40 g/l (14 lb/bbl) or less based on the total volume of the aqueous base treatment fluid.

Surfactant

The aqueous base treatment fluid also comprises a quantity of one or more surfactants. A variety of surfactants may be used as long as the surfactant assists in increasing the viscosity of the treatment fluid upon exposure to at or above the threshold temperature.

The type of surfactant may vary. For example, the type of surfactant may vary with the type of water soluble polymer and/or the type and/or charge of pendant groups on the water soluble polymer. For example, where the water soluble polymer comprises groups susceptible to hydrogen bonding, suitable surfactants generally are substantially non-ionic, and more susceptible to forming hydrogen bonds with the water soluble polymer. Where the water soluble polymer comprises pendant groups that are susceptible to ionic bonding, the surfactant is cationic or anionic, and more susceptible to forming ionic bonds with the water soluble polymer.

The surfactant is a solubilizer between the oil and the aqueous base. In one embodiment, the surfactant is selected from the group consisting of non-ionic surfactant, cationic surfactant, and/or amphoteric surfactant.

Suitable non-ionic surfactants include, for example, ethoxylated long chain and/or branched alcohols, ethoxylated carboxylic acids, and ethoxylated nonylphenols having from about 2 to about 11 ethylene oxide (EO) units, ethoxylated long chain and branched alcohols, ethoxylated carboxylic acids, and ethoxylated esters of glycerol. Suitable alcohols include, for example, alcohols having from 9 to 14 carbon atoms and from 2 to 8 EO units. Suitable branched alcohols include, for example, isopropanol. In one embodiment, the alcohols are ethoxylated tridecanols having 2 to 4 EO units. In one embodiment, the non-ionic surfactant comprises carboxylic acids having from 9 to 14 carbon atoms and from 2 to 8 EO units.

In one embodiment, the surfactant comprises cationic surfactant. Suitable cationic surfactants include, for example, ethoxylated amines and imidazoline derivatives. Suitable ethoxylated amines include, for example, ethoxylated amines having from 8 to 18 carbon atoms and from 2 to 8 EO units. In one embodiment, the cationic surfactant is selected from the group consisting of NP-4-EO and/or NP-6-EO. Suitable imidazoline derivatives include, for example, imidazoline derivatives having from 8 to 16 carbon atoms and from 2 to 8 EO units. In one embodiment, the cationic surfactant comprises one or more ethoxylated fatty amide. In one embodiment, the cationic surfactant is cocodiethanolaminoamide.

In one embodiment, the surfactant is amphoteric surfactant. Suitable amphoteric surfactants include, for example, betaines and amidopropyl betaines having from 8 to 14 carbon atoms.

In one embodiment, the surfactant further comprises one or more additional component selected from the group consisting of demulsifiers, co-surfactants, and/or surface tension modifiers.

Suitable demulsifiers include, for example, 2-ethylhexanol and imidazoline quats. In one embodiment, the demulsifier comprises one or more imidazolinium compounds. In one embodiment, the demulsifier comprise methyl-1-tallow amidoethyl-2-tallow-imidazolinium methosulphate and/or demulsifying polymers. Suitable demulsifying polymers include, for example, those selected from the group consisting of co- and terpolymers of the methacrylic acid type or (partly) ethoxylated abietylamines. In one embodiment, the demulsifier comprises about 90% hydroabiethylamine and/or polyether-modified polysiloxanes. Examples of polyether-modified polysiloxanes this class of compounds are Tegopren 5802 and TEGO Antifoam MR 475 from Goldschmidt GmbH, Essen, which are believed to constitute a typical antifoaming agent with a demulsifying effect.

Aqueous systems thickened with hydrophilic polymers are rendered miscible with oil via the addition of an emulsifier. Demulsifiers normally make it more difficult to form an emulsion. The apparent contradiction can be minimized by using excess surfactant and/or one or more surface tension modifiers. Suitable surface-tension modifiers include, for example, silicone derivatives and/or polymers having (per)fluorinated carbon side chains. In one embodiment, the surface-tension modifier is silicone oil. Suitable silicone oils include, for example, dimethylpolysiloxanes and/or α,ω-difunctional silicone quats. In one embodiment, the surface-tension modifier is dimethylpolysiloxanes (DMPS). DMPS are miscible with most oils and increase the surface tension between the oil phase and the water phase. Functionalized silicone quats, including difunctional silicone quats, such as Tegopren 6921 to 6924 (from Goldschmidt GmbH), accumulate selectively at the phase boundaries and may be more suitable compared with unfunctionalized simple silicone oils.

In general, the use of one or more surface tension modifiers reduces the shear energy required to form the emulsion.

The amount of surfactant in the treatment fluid may vary depending upon the desired threshold temperature. The amount of surfactant generally is sufficient to assist in dispersing the water soluble polymer in the treatment fluid and to produce a desired threshold temperature. In one embodiment, the amount of surfactant in the treatment fluid is about 0.25 vol. % or more, based on the total volume of the treatment fluid. In one embodiment, the amount of surfactant in the treatment fluid is about 0.5 vol. % or more. In one embodiment, the amount of surfactant in the treatment fluid is about 5 vol. % or less. In one embodiment, the amount of surfactant in the treatment fluid is about 3 vol. % or less. As the amount of surfactant in the treatment fluid increases, the threshold temperature generally increases.

In one embodiment, the surfactant comprises emulsifier comprising one or more ethoxylated fatty amide and demulsifier comprising one or more imidazolinium compound. In one embodiment, the surfactant is a POLYBREAK surfactant. A variety of POLYBREAK surfactants are commercially available from BASF (previously Degussa).

Biocide

The treatment fluid is functional in the absence of a biocide. In one embodiment, the treatment fluid comprises one or more biocide.

Suitable biocides comprise substantially any commercially available biocide for use in fluid systems during petroleum recovery operations. In one embodiment, the biocide comprises one or more quaternary amine. Suitable quaternary amines include, for example, cocodimethyl ammonium chloride, dodecyldimethyl ammonium chloride, alkyldimethylbenzyl ammonium chloride, dialkyldimethylbenzyl ammonium chloride, and mixtures thereof. In one embodiment, the biocide comprises oxyhalogen compounds. In one embodiment, the biocide is an X-CIDE®, which is commercially available from Baker Petrolite. A variety of X-CIDE® biocides are available. In one embodiment, the active ingredient in X-CIDE® is glutaraldehyde. In one embodiment, the active ingredient in X-CIDE® is isothiazoline.

In one embodiment, the treatment fluid comprises about 0.1 g/bbl (about 159 liters) or more biocide, based on the total volume of the treatment fluid. In one embodiment, the surfactant comprises about 0.4 g/bbl or more biocide. In one embodiment, the surfactant comprises about 1 g/bbl or less biocide. In one embodiment, the surfactant comprises about 0.6 g/bbl or less biocide.

Other Additives

A wide variety of other additives may be used in the treatment fluid, as long as they do not interfere with the treatment fluid increasing in viscosity upon exposure to at or above a threshold temperature. Such additives include, for example, shale stabilizer(s), filtration control additive(s), suspending agent(s), dispersant(s), thinner(s), anti-balling additive(s), lubricant(s), weighting agent(s), seepage control additive(s), other lost circulation additive(s), drilling enhancer(s), penetration rate enhancer(s), corrosion inhibitor(s), acid(s), base(s), buffer(s), scavenger(s), gelling agent(s), cross-linker(s), catalyst(s), soluble salts, biocides; one or more bridging and/or weighting agents, and combinations thereof.

In one embodiment, the treatment fluid comprises one or more scale inhibitors. Examples of scales that may form during fracturing operations include, for example, carbonate scales and sulfate scales. Scale can block equipment used during petroleum recovery operations. Scale also can create fines that block the pores of a subterranean formation. Where used, suitable scale inhibitors include, for example, polyaspartates; hydroxyaminocarboxylic acid (HACA) chelating agents, such as hydroxyethyliminodiacetic acid (HEIDA); ethylenediaminetetracetic acid (EDTA), diethylenetriaminepentaacetic acid (DTPA), nitrilotriacetic acid (NTA) and other carboxylic acids and salts thereof, phosphonates, acrylates, and combinations thereof.

### Formulation and Preparation of the Aqueous Base Treatment Fluid

The aqueous base treatment fluid may be prepared in a variety of ways. In one embodiment, the one or more water-soluble polymers are mixed with the aqueous base under conditions effective to hydrate the one or more water-soluble polymers. In one embodiment, the conditions comprise mixing with agitation. In one embodiment, surfactant is added to the resulting mixture under conditions effective to assist in dispersing the one or more water-soluble polymer in the aqueous base. In one embodiment, oil is added to the resulting dispersion under conditions effective to produce an oil-in-water emulsion comprising an aqueous base comprising the hydrated water soluble polymers dispersed therein.

The treatment fluid may be formulated to have a desired threshold temperature. The desired threshold temperature may be produced in several ways. For example, assume that a treatment fluid has a threshold temperature “X.” In one embodiment, the threshold temperature is increased to greater than “X” by: (a) increasing the pH; (b) increasing the concentration of surfactant; and/or, (c) decreasing the amount of oil in the treatment fluid. In one embodiment, the threshold temperature is increased to greater than X by only one of (a)-(c). In one embodiment, the threshold temperature is increased to greater than X by more than one of (a)-(c). In one embodiment, the threshold temperature is increased to greater than X by all of (a), (b), and (c).

An increase in pH, alone, may be sufficient to increase the threshold temperature of a treatment fluid to greater than X. In one embodiment, the treatment fluid is formulated to have a pH of from about 8 to about 11. In one embodiment, the treatment fluid is formulated to have a pH of about 10 or more.

In one embodiment, the threshold temperature of the treatment fluid is decreased to less than X by one or more of (a) decreasing the pH; (b) decreasing the concentration of surfactant; and/or, (c) increasing the amount of oil. In one embodiment, the threshold temperature of the treatment fluid is decreased to less than X by only one of (a)-(c). In one embodiment, the threshold temperature of the treatment fluid is decreased to less than X by more than one of (a)-(c). In one embodiment, the threshold temperature of the treatment fluid is decreased to less than X by all of (a), (b), and (c).

A decrease in pH, alone, may be sufficient to decrease the threshold temperature of the treatment fluid to less than X. In one embodiment, the treatment fluid is formulated to have a pH of less than 11. In one embodiment, the treatment fluid is formulated to have a pH of less than 10.5. In one embodiment, the treatment fluid is formulated to have a pH of less than 10. In one embodiment, the treatment fluid is formulated to have a pH of less than 9.

In one embodiment, the pH is adjusted using a suitable organic base as a buffer. Substantially any buffer may be used as long as it does not interfere with viscosification of the treatment fluid upon exposure to at or about the threshold temperature. Suitable buffers include, for example, ethanolamines, alkali metal hydroxides, and alkali metal acetates. In one embodiment, the alkali metal is sodium or potassium.

### Method of Using the Aqueous Base Treatment Fluid

The aqueous base treatment fluid may be used in any application in which it is desirable for the viscosity to increase upon exposure to an increase in temperature.

Generally

In one embodiment, the aqueous base treatment fluid is used in a method of treating a subterranean formation. The method comprises: measuring a threshold temperature at a location in the subterranean formation having an initial permeability; and, transporting to the location the aqueous base treatment fluid comprising a quantity of one or more polysaccharides, a concentration of oil emulsified in the aqueous base, and an amount of surfactant. In the method, the treatment fluid increases in viscosity upon exposure to temperatures at or above the threshold temperature and produces an increased viscosity treatment fluid which reduces the initial permeability at the location to a reduced permeability.

In one embodiment, the method further comprises remediating the wellbore. The wellbore may be remediated in a variety of ways. In one embodiment, the wellbore is remediated by decreasing the viscosity of the aqueous base treatment fluid. In one embodiment, after decreasing viscosity of the treatment fluid to a reduced viscosity, the reduced viscosity aqueous base treatment fluid is removed from the wellbore.

In one embodiment, the reduced viscosity aqueous base treatment fluid is recovered by flowing naturally from the formation under the influence of formation fluids. In one embodiment, a viscosity breaker is injected to reduce the viscosity or “break” the viscosity of the increased viscosity treatment fluid. Common viscosity breakers include enzymes, oxidizers, and acids. Enzymes typically are effective within a relatively low pH range, for example, from about 2.0 to about 10.0. The enzymes typically increase in activity as the pH is lowered towards neutral from a pH of about 10.0.

Where an enzyme type viscosity breaker is contemplated, the aqueous base treatment fluid may comprise enzyme breaker (protein) stabilizers. These compounds stabilize the enzymes and/or proteins in the aqueous base treatment fluid so that they are effective to reduce viscosity after the formation has been fractured. Suitable enzyme breaker stabilizers include, for example, sorbitol, mannitol, glycerol, citrates, aminocarboxylic acids and their salts (EDTA, DTPA, NTA, etc.), phosphonates, sulfonates and mixtures thereof.

Lost Circulation Pill

In one embodiment, the aqueous base treatment fluid is used as a lost circulation pill. Where used as a lost circulation pill, the aqueous base treatment fluid may be used to treat both producing and non-producing intervals of the wellbore. Where used as a lost circulation pill, the aqueous base treatment fluid is injected into a loss zone having a temperature at or above the threshold temperature of the aqueous base treatment fluid. When subjected to at or above the threshold temperature, the aqueous base treatment fluid increases in viscosity and seals pores or fractures in the loss zone. If desired, the loss zone can be remediated by later removing the viscosified treatment fluid. In one embodiment, the loss zone is remediated by (a) increasing the pH of the treatment fluid to 10 or greater using a suitable base and/or (b) increasing the amount of oil in the treatment fluid.

The amount of oil that is added to a treatment fluid to break viscosity will vary. In one embodiment, the amount of added oil varies depending upon the pH of the treatment fluid and the type of oil. Where the oil is paraffin, the amount of paraffin in the treatment fluid is increased to about 10 vol. % or more. In one embodiment, the amount of paraffin in the treatment fluid is increased to about 15 vol. % or less.

Fracturing Fluid

In one embodiment, the aqueous base treatment fluid is used as a fracturing fluid. Hydraulic fracturing is a method of using pump rate and hydraulic pressure to fracture or crack a subterranean formation. Once the crack or cracks are made, high permeability proppant, relative to the formation permeability, is pumped into the fracture to prop open the crack. When the applied pump rates and pressures are reduced or removed from the formation, the high permeability proppant keeps the crack open. The propped crack or fracture provides a high permeability path connecting the producing wellbore to a larger formation area to enhance the production of hydrocarbons.

In one embodiment, the method of using the aqueous base treatment fluid as a fracturing fluid comprises: pumping the aqueous base treatment fluid comprising an initial viscosity down a wellbore to a subterranean formation; increasing the viscosity of the aqueous base treatment fluid to an increased viscosity aqueous base treatment fluid; pumping the increased viscosity aqueous base treatment fluid into the formation at a sufficient rate and pressure to fracture the formation.

In one embodiment, the method further comprises remediating the fractured formation. In one embodiment, remediating comprises reducing the viscosity of the increased viscosity aqueous base treatment fluid, and subsequently recovering a reduced viscosity aqueous base treatment fluid from the formation. In one embodiment, the method further comprises leaving the increased viscosity aqueous base treatment fluid in the formation for a relatively extended period of time. In one embodiment, the increased viscosity aqueous base treatment fluid is left in the formation indefinitely.

In one embodiment, remediating the fractured formation comprises pumping a viscosity breaker downhole and into contact with the increased viscosity aqueous base treatment fluid. In one embodiment, the viscosity breaker reduces the viscosity of the increased viscosity aqueous base treatment fluid and provides a free flowing reservoir for hydrocarbon production. In one embodiment, the treatment fluid comprises an internal viscosity breaker. In one embodiment, the internal viscosity breaker is encapsulated and released over time as the encapsulating material disintegrates. Disintegration of the encapsulating material may be in response to a variety of factors.

The application will be better understood with reference to the following examples, which are illustrative only and should not be construed as limiting the claims.

### Example 1

POLYBREAK is a surfactant which previously was commercially available from DeGussa, and is now commercially available from BASF. POLYBREAK A and D are surfactants comprising a blend of ethoxylated fatty amide emulsifier, imidazolinium based de-emulsifier, and 2-isopropyl alcohol. According to advertising, POLYBREAK A and D breaks the viscosity of polymeric-based fluids when contacted with excess amounts of oil, particular relatively non-polar oil.

The mechanism by which POLYBREAK breaks viscosity is unclear. Microscopic observations indicate that a water-in-oil-in-water double emulsion may be produced.

Tests were performed to determine whether POLYBREAK A and D could reduce the viscosity of a drilling fluid system when drilling into a reservoir. The formulations in the following Table were prepared.

| | A | | B | | C | | D | | E | |
|---|---|---|---|---|---|---|---|---|---|---|
| Water, l bbl or | 0.9770 | (0.9770) | 0.9770 | (0.9770) | 0.9586 | (0.9586) | 0.9586 | (0.9586) | 0.9586 | (0.9586) |
| approx. 159 liters | | | | | | | | | | |
| NaCl, g(lb) | 54.1 | (18.97) | 54.1 | (18.97) | — | | — | | — | |
| KCl, g(lb) | — | | — | | 31.4 | (11.02) | 31.4 | (11.02) | 31.4 | (11.02) |
| Sodium Formate, g(lb) | — | | — | | 7.1 | (2.5) | 7.1 | (2.5) | 7.1 | (2.5) |
| XAN-PLEX ® D, g(lb) | 5.7 | (2) | 5.7 | (2) | 2.85 | (1) | 2.85 | (1) | 2.85 | (1) |

| BIO-PAQ ®, g(lb) | — | — | 17.1 | (6) | 17.1 | (6) | 17.1 | (6) |
|---|---|---|---|---|---|---|---|---|
| MagOx, g(lb) | — | — | 1.4 | (0.5) | 1.4 | (0.5) | 1.4 | (0.5) |
| MIL-CARB ®, g(lb) | — | — | — | | — | | — | |
| REV DUST ™, g(lb) | — | — | — | | — | | — | |
| X-CIDE ® 102, g(lb) | — | — | 0.6 | (0.2) | 0.6 | (0.2) | 0.6 | (0.2) |

| PolyBreak A, % v | — | — | 1 | 1 | 1 |
|---|---|---|---|---|---|
| PolyBreak D, % v | 1 | — | — | — | — |
| Crude Oil, % v | — | — | — | — | 30.0% |
| Diesel, % v | — | 30.0% | — | 30.0% | — |

Samples hot-rolled 16 hours @ 66° C. (150° F.) & Tested on FANN 35 viscometer @ 49° C. (120° F.)

| | | | | | |
|---|---|---|---|---|---|
| 600-rpm | 31 | 37 | 46 | 36 | 77 |
| 300-rpm | 26 | 25 | 37 | 23 | 45 |
| 200-rpm | 24 | 20 | 32 | 17 | 32 |
| 100-rpm | 20 | 14 | 26 | 11 | 21 |
| 6-rpm | 12 | 4 | 12 | 2 | 5 |
| 3-rpm | 10 | 3 | 10 | 2 | 3 |
| Plastic Visc., cP | 5 | 12 | 9 | 13 | 32 |
| YP, kg/cm² | 21 | 13 | 28 | 10 | 13 |
| (lb/100 ft²) | | | | | |

Chandler 3500LS viscometer @ 49° C.(120° F.)

| 60-rpm | 93 | | 36 | | 126 | | 32 | | 67 | |
|---|---|---|---|---|---|---|---|---|---|---|
| 30-rpm | 81 | | 22 | | 102 | | 17 | | 45 | |
| 20-rpm | 75 | | 17 | | 91 | | 11 | | 35 | |
| 10-rpm | 67 | | 13 | | 75 | | 7 | | 24 | |
| 6-rpm | 61 | | 10 | | 66 | | 6 | | 17 | |
| 3-rpm | 54 | | 8 | | 55 | | 5 | | 11 | |
| 2-rpm | 50 | | 7 | | 49 | | 4 | | 9 | |
| 1-rpm | 43 | | 6 | | 41 | | 4 | | 6 | |
| 0.6-rpm | 38 | | 5 | | 35 | | 4 | | 5 | |
| 0.3-rpm | 32 | | 5 | | 29 | | 3 | | 4 | |
| 0.2-rpm | 29 | | 4 | | 25 | | 3 | | 3 | |
| 0.1-rpm | 23 | | 4 | | 20 | | 3 | | 2 | |
| | F | | G | | H | | I | | J | |
| Water, l bbl or | 0.9586 | (0.9586) | 0.9275 | (0.9275) | 0.9275 | (0.9275) | 0.9294 | (0.9294) | 0.9294 | (0.9294) |
| approx. 159 liters | | | | | | | | | | |
| NaCl, g(lb) | — | | — | | — | | — | | — | |
| KCl, g(lb) | 31.4 | (11.02) | 30.4 | (10.66) | 30.4 | (10.66) | 30.5 | (10.69) | 30.5 | (10.69) |
| Sodium Formate, g(lb) | 7.1 | (2.5) | 7.1 | (2.5) | 7.1 | (2.5) | 7.1 | (2.5) | 7.1 | (2.5) |
| XAN-PLEX ® D, g(lb) | 2.85 | (1) | 2.85 | (1) | 2.85 | (0) | 2.85 | (0) | 2.85 | (1) |
| BIO-PAQ ®, g(lb) | 17.1 | (6) | 17.1 | (6) | 17.1 | (6) | 17.1 | (6) | 17.1 | (6) |
| MagOx, g(lb) | 1.4 | (0.5) | 1.4 | (0.5) | 1.4 | (0.5) | 1.4 | (0.5) | 1.4 | (0.5) |
| MIL-CARB ®, g(lb) | — | | 85.6 | (30) | 85.6 | (30) | — | | — | |
| REV DUST ™, g(lb) | — | | — | | — | | 77 | (27) | 77 | (27) |
| X-CIDE ® 102, g(lb) | 0.6 | (0.2) | 0.6 | (0.2) | 0.6 | (0.2) | 0.6 | (0.2) | 0.6 | (0.2) |

| PolyBreak A, % v | 1 | 1 | 1 | 1 | — |
|---|---|---|---|---|---|
| PolyBreak D, % v | — | — | — | — | — |
| Crude Oil, % v | 50.0% | — | — | — | — |
| Diesel, % v | — | — | 30.0% | — | 30.0% |

Samples hot-rolled 16 hours @ 66° C. (150° F.) & Tested on FANN 35 viscometer @ 49° C. (120° F.)

| | | | | | |
|---|---|---|---|---|---|
| 600-rpm | 53 | 58 | 42 | 55 | 61 |
| 300-rpm | 32 | 45 | 26 | 43 | 43 |
| 200-rpm | 25 | 39 | 20 | 38 | 35 |
| 100-rpm | 36 | 31 | 12 | 30 | 20 |
| 6-rpm | 3 | 13 | 5 | 13 | 9 |
| 3-rpm | 3 | 11 | 3 | 11 | 6 |
| Plastic Visc., cP | 21 | 13 | 16 | 12 | 18 |
| YP, kg/cm² | 11 | 32 | 10 | 31 | 25 |
| (lb/100 ft²) | | | | | |

Chandler 3500LS viscometer @ 49° C.(120° F.)

| | | | | | |
|---|---|---|---|---|---|
| 60-rpm | 68 | 139 | 49 | 137 | 89 |
| 30-rpm | 43 | 110 | 29 | 110 | 57 |
| 20-rpm | 33 | 97 | 20 | 97 | 43 |
| 10-rpm | 21 | 78 | 12 | 79 | 25 |
| 6-rpm | 16 | 67 | 7 | 69 | 17 |
| 3-rpm | 10 | 54 | 4 | 56 | 15 |
| 2-rpm | 8 | 48 | 3 | 50 | 15 |
| 1-rpm | 6 | 39 | 2 | 41 | 14 |
| 0.6-rpm | 5 | 33 | 2 | 35 | 13 |
| 0.3-rpm | 4 | 26 | 2 | 27 | 11 |
| 0.2-rpm | 3 | 22 | 2 | 24 | 10 |
| 0.1-rpm | 2 | 18 | 2 | 18 | 8 |

In the foregoing Table, REV-DUST™ is a simulated drilled product which may be obtained from Mil-White Company, Houston, Tex. MAGOX is magnesium oxide, which is commercially available from a variety of commercial sources. The following products are commercially available from Baker Hughes Drilling Fluids: XAN-PLEX® D, a blend of modified polysaccharides; BIO-PAQ®, a blend of synthetically modified starches; and, X-CIDE® 102, an aldehyde type biocide for use in water-based drilling fluids; SCI-FLOW™, a low-density drill-in fluid system for drilling pressure depleted reservoirs; MIL-CARB®, sized, metamorphic calcium carbonate blends used as bridging agents and loss circulation material.

As seen from the Table, POLYBREAK A and D were tested at concentrations of from about 0 vol. % to about 4 vol. % with and without MIL-CARB® and REV DUST™ in (a) 5.7 g/l (2-lb/bbl) XAN-PLEX® D in 10 wt. % NaCl, and (b) SCI-FLOW™.

Diesel and crude oil were tested as organic breakers. When the diesel was mixed into the fluid at low shear with a 2-hour hot roll at 66° C. (150° F.), the plastic viscosity (PV) increased slightly and the yield point (YP) dropped dramatically. Additionally, the viscosity of the blend with diesel fluid was significantly lower than the viscosity of the base fluid when tested below 200-rpm on a FANN 35 or Chandler 3500LS viscometer. The diesel tended to separate rapidly from the bulk fluid, so accurate measurements were difficult to obtain. Viscosity was broken to a lesser degree when crude oil was mixed into the fluid, although slightly better results were achieved using a higher volume of crude oil in one sample (50 vol %).

The addition of MIL-CARB® did not appear to impact the breaking of viscosity in the systems to which diesel was added. However, the addition of REV DUST™ resulted in a higher rheology after mixing the fluid with diesel. This was true even though the rheology of the fluid was similar to the rheology of the fluid containing MIL-CARB® before diesel addition.

### Example 2

The compositions shown below were formulated, hot rolled under the indicated conditions, and the rheology was tested. The following components were added to some formulations and not to others: sodium formate; MAGOX; POLYBREAK 10; and, SIPDRILL™ 4/0, a paraffin fluid commercially available from SIP Ltd., UK. The results are given in the following Table:

| Sample No. | K | | L | | M | | N | | O | |
|---|---|---|---|---|---|---|---|---|---|---|
| Water, l bbl or | 0.9091 | (0.9091) | 0.9091 | (0.9091) | 0.9718 | (0.9718) | 0.9130 | (0.9130) | 0.9126 | (0.9126) |
| approx. 159 liters | | | | | | | | | | |
| KCl, g (lb) | 29.8 | (10.45) | 29.8 | (10.45) | 31.6 | (11.09) | 29.7 | (10.42) | 29.7 | (10.41) |
| Sodium Formate, g (lb) | 7.1 | (2.5) | 7.1 | (2.5) | — | | — | | — | |
| XAN-PLEX ® D, g (lb) | 2.85 | (1) | 2.85 | (1) | 2.85 | (1) | 2.85 | (1) | 2.85 | (1) |
| BIO-PAQ ®, g (lb) | 17.1 | (6) | 17.1 | (6) | 17.1 | (6) | 17.1 | (6) | 17.1 | (6) |
| MagOx, g (lb) | 1.4 | (0.5) | — | | 1.4 | (0.5) | — | | 1.4 | (0.5) |
| NaOH, g (lb) | — | | — | | — | | — | | — | |
| X-CIDE ® 102, g (lb) | 0.6 | (0.2) | 0.6 | (0.2) | 0.6 | (0.2) | 0.6 | (0.2) | 0.6 | (0.2) |

| | | | | | |
|---|---|---|---|---|---|
| PolyBreak 10, % v | 1 | 1 | — | 1 | 1 |
| SIPDRILL 4/0 (paraffin | 5.0% | 5.0% | — | 5.0% | 5.0% |
| oil), % v | | | | | |

Samples hot-rolled 16 hours @ 66° C. (150° F.) & Tested on FANN 35 @ 24° C. (75° F.)

| 600-rpm Reading | 63 | | 57 | | 56 | | 59 | | 61 | |
|---|---|---|---|---|---|---|---|---|---|---|
| 300-rpm Reading | 46 | | 41 | | 43 | | 43 | | 45 | |
| 200-rpm Reading | 39 | | 34 | | 37 | | 35 | | 38 | |
| 100-rpm Reading | 29 | | 24 | | 29 | | 26 | | 28 | |
| 6-rpm Reading | 10 | | 8 | | 15 | | 8 | | 11 | |
| 3-rpm Reading | 8 | | 6 | | 11 | | 6 | | 8 | |
| Plastic Viscosity, cP | 17 | | 16 | | 13 | | 16 | | 16 | |
| Yield Point, Pa | 13.9 | (29) | 12 | (25) | 14.4 | (30) | 12.9 | (27) | 13.9 | (29) |
| (lb/100 ft²) | | | | | | | | | | |

FANN 35 @ 49° C. (120° F.)

| 600-rpm Reading | 48 | | 110 | | 44 | | 48 | | 46 | |
|---|---|---|---|---|---|---|---|---|---|---|
| 300-rpm Reading | 37 | | 90 | | 35 | | 36 | | 35 | |
| 200-rpm Reading | 31 | | 79 | | 30 | | 32 | | 30 | |
| 100-rpm Reading | 23 | | 57 | | 23 | | 29 | | 22 | |
| 6-rpm Reading | 9 | | 12 | | 14 | | 6 | | 11 | |
| 3-rpm Reading | 7 | | 8 | | 9 | | 4 | | 7 | |
| Plastic Viscosity, cP | 11 | | 20 | | 9 | | 12 | | 11 | |
| Yield Point, Pa | 12.4 | (26) | 33.5 | (70) | 12.4 | (26) | 11.5 | (24) | 11.5 | (24) |
| (lb/100 ft²) | | | | | | | | | | |
| Sample No. | P | | Q | | R | | S | | T | |
| Water, l bbl or | 0.9087 | (0.9087) | 0.9620 | (0.9620) | 0.9624 | (0.9624) | 0.9169 | (0.9169) | 0.9267 | (0.9267) |
| approx. 159 liters | | | | | | | | | | |
| KCl, g (lb) | 29.8 | (10.45) | 31.3 | (10.98) | 31.3 | (10.98) | 28.4 | (9.94) | 28.7 | (10.05) |
| Sodium Formate, g (lb) | 7.1 | 2.5 | — | | — | | — | | — | |
| XAN-PLEX ® D, g (lb) | 2.85 | (1) | 2.85 | (1) | 2.85 | (1) | — | | 2.85 | (1) |
| BIO-PAQ ®, g (lb) | 17.1 | (6) | 17.1 | (6) | 17.1 | (6) | 17.1 | (6) | — | |
| MagOx, g (lb) | 2.85 | (1) | 1.4 | (0.5) | — | | — | | — | |
| NaOH, g (lb) | — | | — | | — | | — | | — | |
| X-CIDE ® 102, g (lb) | 0.6 | (0.2) | 0.6 | (0.2) | 0.6 | (0.2) | 0.6 | (0.2) | 0.6 | (0.2) |

| PolyBreak 10, % v | 1 | 1 | 1 | 1 | 1 |
|---|---|---|---|---|---|
| SIPDRILL 4/0 (paraffin | 5.0% | — | — | 5.0% | 5.0% |
| oil), % v | | | | | |

Samples hot-rolled 16 hours @ 66° C. (150° F.) & Tested on FANN 35 @ 24° C. (75° F.)

| 600-rpm Reading | 58 | | 62 | | 61 | | 13 | | 17 | |
|---|---|---|---|---|---|---|---|---|---|---|
| 300-rpm Reading | 43 | | 48 | | 45 | | 7 | | 16 | |
| 200-rpm Reading | 35 | | 41 | | 38 | | 5 | | 12 | |
| 100-rpm Reading | 26 | | 32 | | 28 | | 3 | | 8 | |
| 6-rpm Reading | 9 | | 16 | | 10 | | 1 | | 3 | |
| 3-rpm Reading | 7 | | 12 | | 8 | | 1 | | 3 | |
| Plastic Viscosity, cP | 15 | | 14 | | 16 | | 6 | | 1.7 | |
| Yield Point, Pa | 13.4 | (28) | 16.3 | (34) | 13.9 | (29) | 0.5 | (1) | 6.7 | (13.9) |
| (lb/100 ft²) | | | | | | | | | | |

FANN 35 @ 49° C. (120° F.)

| 600-rpm Reading | 44 | | 48 | | 46 | | 12 | | 40 | |
|---|---|---|---|---|---|---|---|---|---|---|
| 300-rpm Reading | 33 | | 38 | | 35 | | 7 | | 37 | |
| 200-rpm Reading | 28 | | 33 | | 29 | | 5 | | 31 | |
| 100-rpm Reading | 20 | | 26 | | 22 | | 3 | | 26 | |
| 6-rpm Reading | 7 | | 15 | | 8 | | 1 | | 6 | |
| 3-rpm Reading | 5 | | 9 | | 6 | | 1 | | 4 | |
| Plastic Viscosity, cP | 11 | | 10 | | 11 | | 5 | | 3 | |
| Yield Point, Pa | 10.5 | (22) | 13.4 | (28) | 11.5 | (24) | 1 | (2) | 15.8 | (33) |
| (lb/100 ft²) | | | | | | | | | | |

In sample S, the treatment fluid comprising POLYBREAK and BIO-PAQ® but not XAN-PLEX®-D did not maintain effective viscosity. Generally, where XAN-PLEX®-D, MAGOX or NaOH, and 5 vol. % SIPDRILL™ were present, the plastic viscosity and yield point of the treatment fluid were consistently lower after aging.

### Example 3

A number of formulas were prepared with XAN-PLEX®-D and 5 vol. % SIPDRILL™, but without MAGOX, varying the presence and quantity of BIO-PAQ® and POLYBREAK 10. POLYBREAK 10 also is commercially available from BASF. The compositions were hot rolled, as indicated, and initial and final plastic viscosity and yield point were assessed. The results are given in the following Table:

| Sample No. | U | | V | | W | |
|---|---|---|---|---|---|---|
| Water, l bbl or | .9176 | (0.9176) | .9126 | (0.9126) | .9028 | (0.9028) |
| approx. | | | | | | |
| 159 liters | | | | | | |
| KCl, g (lb) | 29.9 | (10.47) | 29.7 | (10.41) | 29.4 | (10.3) |
| Sodium Formate, g | — | | — | | — | |
| (lb) | | | | | | |
| XAN-PLEX ® D, g (lb) | 2.85 | (1) | 2.85 | (1) | 2.85 | (1) |
| BIO-PAQ ®, g (lb) | 17.1 | (6) | 17.1 | (6) | 17.1 | (6) |
| MagOx, g (lb) | — | | — | | — | |
| NaOH, g (lb) | — | | — | | — | |
| X-CIDE ® 102, g (lb) | 0.6 | (0.2) | 0.6 | (0.2) | 0.6 | (0.2) |

| | | | |
|---|---|---|---|
| POLYBREAK 10, % v | 0.5 | 1 | 2 |
| SIPDRILL 4/0 | 5.0% | 5.0% | 5.0% |
| (paraffin oil), vol % | | | |

Samples hot-rolled 16 hours @ 66° C. (150° F.) & Tested on FANN 35 @ 24° C. (75° F.)

600-rpm Reading
300-rpm Reading
200-rpm Reading
100-rpm Reading
6-rpm Reading
3-rpm Reading
Plastic Viscosity, cP
Yield Point, kg/cm²
(lb/100 ft²)

FANN 35 @ 49° C. (120° F.)

| 600-rpm Reading | 75 | | 47 | | 49 | |
|---|---|---|---|---|---|---|
| 300-rpm Reading | 60 | | 34 | | 36 | |
| 200-rpm Reading | 52 | | 28 | | 30 | |
| 100-rpm Reading | 39 | | 20 | | 22 | |
| 6-rpm Reading | 15 | | 6 | | 11 | |
| 3-rpm Reading | 9 | | 5 | | 6 | |
| Plastic Viscosity, cP | 15 | | 13 | | 13 | |
| Yield Point, kg/cm² | 21.5 | (45) | 10.1 | (21) | 11 | (23) |
| (lb/100 ft²) | | | | | | |
| 600-rpm Reading | 112 | | 148 | | 154 | |
| 300-rpm Reading | 88 | | 125 | | 112 | |
| 200-rpm Reading | 75 | | 105 | | 39 | |
| 100-rpm Reading | 55 | | 71 | | 31 | |
| 6-rpm Reading | 19 | | 18 | | 7 | |
| 3-rpm Reading | 14 | | 15 | | 6 | |
| Plastic Viscosity, cP | 24 | | 23 | | 42 | |
| Yield Point, kg/cm² | 30.6 | (64) | 48.8 | (102) | 33.5 | (70) |
| (lb/100 ft²) | | | | | | |

None of the compositions demonstrated the relatively low plastic viscosity and yield point values seen when MAGOX (or NaOH) was present.

### Example 4

In order to determine whether pH was a factor in the results observed in Example 3, formulations were prepared with either MAGOX or with 113.4 g (0.25 lb) NaOH:

| Sample No. | X | | Y | |
|---|---|---|---|---|
| Water, l bbl or | 0.9126 | (0.9126) | 0.9126 | (0.9126) |
| approx. | | | | |
| 159 liters | | | | |
| KCl, g (lb) | 29.7 | (10.41) | 29.7 | (10.41) |
| Sodium Formate, g (lb) | — | | — | |
| XAN-PLEX ® D, g (lb) | 2.85 | (1) | 2.85 | (1) |
| BIO-PAQ ®, g (lb) | 17.1 | (6) | 17.1 | (6) |
| MagOx, g (lb) | — | | 14.3 | (5) |
| NaOH, g (lb) | 0.7 | (0.25) | — | |
| X-CIDE ® 102, g (lb) | 0.6 | (0.2) | 0.6 | (0.2) |

| | | |
|---|---|---|
| PolyBreak 10, % v | 1 | 1 |
| SIPDRILL 4/0 | 5.0% | 5.0% |
| (paraffin oil), vol % | | |

Samples hot-rolled 16 hours @ 66° C.
(150° F.) & Tested on FANN 35 @ 24° C. (75° F.)

| 600-rpm Reading | 44 | | 50 | |
|---|---|---|---|---|
| 300-rpm Reading | 34 | | 38 | |
| 200-rpm Reading | 29 | | 32 | |
| 100-rpm Reading | 22 | | 24 | |
| 6-rpm Reading | 11 | | 12 | |
| 3-rpm Reading | 8 | | 9 | |
| Plastic Viscosity, cP | 10 | | 12 | |
| Yield Point, kg/cm² | 11.5 | (24) | 12.4 | (26) |
| (lb/100 ft²) | | | | |

FANN 35 @ 49° C. (150° F.)

| 600-rpm Reading | 39 | | 47 | |
|---|---|---|---|---|
| 300-rpm Reading | 30 | | 35 | |
| 200-rpm Reading | 25 | | 29 | |
| 100-rpm Reading | 19 | | 21 | |
| 6-rpm Reading | 7 | | 7 | |
| 3-rpm Reading | 5 | | 5 | |
| Plastic Viscosity, cP | 9 | | 12 | |
| Yield Point, kg/cm² | 10.1 | (21) | 11.0 | (23) |
| (lb/100 ft²) | | | | |

Both formulas exhibited similar plastic viscosity and yield point properties. Based on the foregoing, it was determined that a treatment fluid comprising XAN-PLEX®-D, POLYBREAK 10, and SIPDRILL was effective to maintain effective plastic viscosity and yield point as long as the pH was maintained sufficiently high. Extrapolating from these results, it was concluded that a treatment fluid comprising one or more water soluble polysaccharide, one or more oil, and one or more surfactant would increase in viscosity at a pH above 7. In one embodiment, the pH is from about 8 to about 11.

Persons of ordinary skill in the art will recognize that many modifications may be made to the embodiments described herein. The embodiments described herein are meant to be illustrative only and should not be taken as limiting the invention, which will be defined in the claims.

I claim:

1. A treatment fluid comprising:
aqueous base comprising a combination of components effective to viscosify the treatment fluid upon exposure to a temperature at or above a threshold temperature, the treatment fluid having a pH of greater than 7;
the combination of components comprising:
a concentration of oil emulsified in the aqueous base;
a quantity of water soluble polymer comprising one or more polysaccharides having a weight average molecular weight of about 500,000 to about 2,500,000; and
an amount of surfactant.

2. The treatment fluid of claim 1 exhibiting an initial yield point wherein, upon exposure to temperatures at or above the threshold temperature, the treatment fluid exhibits an increased yield point which is about 30% or more greater than the initial YP.

3. The treatment fluid of claim 1 wherein the treatment fluid exhibits an initial plastic viscosity (PV) wherein, upon exposure to temperatures at or above the threshold temperature, the treatment fluid exhibits an increased PV which is about 20% or more greater than the initial PV.

4. The treatment fluid of claim 1 wherein the treatment fluid exhibits an initial plastic viscosity (PV) and, upon exposure to temperatures at or above the threshold temperature, the treatment fluid exhibits an increased PV which is about 30% or more greater than the initial PV.

5. The treatment fluid of claim 1 wherein the treatment fluid exhibits an initial plastic viscosity (PV) and, upon exposure to at or greater than a threshold temperature, the treatment fluid exhibits an increased PV which is about 40% or more greater than the initial PV.

6. The treatment fluid of claim 1 exhibiting an initial YP and, upon exposure to temperatures at or above the threshold temperature, the treatment fluid exhibits an increased YP which is about 100% or more greater than the initial YP.

7. The treatment fluid of claim 1-5 or 6 wherein the surfactant comprises:
one or more emulsifier comprising one or more ethoxylated fatty amide; and,
one or more demulsifier comprising one or more imidazolinium compound.

8. The treatment fluid of claim 1-5 or 6 wherein:
the concentration of oil emulsified in the aqueous base is from about 2 vol. % to about 7 vol. %;
the amount of surfactant is from about 0.5 vol. % to about 3 vol. %; and,
the pH is from about 8 to about 11.

9. The treatment fluid of claim 7 wherein:
the concentration of oil emulsified in the aqueous base is from about 2 vol. % to about 7 vol. %;
the amount of surfactant is from about 0.5 vol. % to about 3 vol. %; and,
the pH is from about 8 to about 11.

10. A method of formulating an aqueous base treatment fluid having a threshold temperature, the method comprising:
mixing an aqueous base with an amount of surfactant and a quantity of water soluble polymer comprising one or more polysaccharides having a weight average molecular weight of about 500,000 to about 2,500,000 under conditions effective to hydrate and disperse the polysaccharides in the aqueous base;
emulsifying a concentration of oil in the aqueous base, producing an oil-in-water emulsion; and,
adjusting the threshold temperature of the oil-in-water emulsion by adjusting one or more of the pH, the concentration of oil, and the concentration of surfactant, thereby producing a treatment fluid having a predetermined threshold temperature.

11. The method of claim 10 wherein adjusting the threshold temperature of the oil-in-water emulsion comprises increasing the threshold temperature of the oil-in-water emulsion by one or more of:
increasing the pH of the oil-in-water emulsion;
decreasing the concentration of oil of the oil-in-water emulsion; and,
increasing the amount of surfactant of the oil-in-water emulsion.

12. The method of claim 10 wherein the adjusting the threshold temperature of the oil-in-water emulsion comprises decreasing the threshold temperature of the oil-in-water emulsion by one or more of:
decreasing the pH of the oil-in-water emulsion;
increasing the concentration of oil in the oil-in-water emulsion; and,
decreasing the amount of surfactant in the oil-in-water emulsion.

13. A method of treating a subterranean formation, the method comprising:
measuring a threshold temperature at a location in the subterranean formation having an initial permeability; and,
transporting to the location an aqueous base treatment fluid having a pH of greater than 7 which increases in viscosity upon exposure to temperatures at or above the threshold temperature, the treatment fluid comprising a quantity of one or more polysaccharides, a concentration of oil emulsified in the aqueous base, and an amount of surfactant, the quantity, the concentration, and the amount being effective to produce an increased viscosity aqueous base treatment fluid and to reduce the initial permeability at the location.

14. The method of claim 13 wherein transporting to the location the aqueous base treatment fluid comprises injecting the aqueous base treatment fluid into a loss zone having a temperature at or above the threshold temperature.

15. The method of claim 13 wherein transporting to the location an aqueous base treatment fluid comprises:
pumping the aqueous base treatment fluid comprising an initial viscosity down the wellbore to the location, thereby producing the increased viscosity aqueous base treatment fluid;
pumping the increased viscosity aqueous base treatment fluid into the subterranean formation at a sufficient rate and pressure to fracture the formation.

16. The method of claim 13 wherein loss of circulation is occurring at the location and the increased viscosity treatment fluid reduces the loss of circulation.

17. The method of claim 13 further comprising fracturing the formation by pumping additional treatment fluid into the formation after producing the increased viscosity treatment fluid.

18. The method of claim 16 further comprising fracturing the formation by pumping additional treatment fluid into the formation after producing the increased viscosity treatment fluid.

19. The method of claim 13 wherein:
the aqueous base treatment fluid exhibits one or more of an initial YP and an initial PV; and,
wherein the increased viscosity treatment fluid exhibits one or more of an increased YP which is about 30% or more greater than the initial YP, and an increased PV which is about 30% or more greater than the initial PV.

20. The method of claim 13-18 or 19 further comprising remediating the wellbore by decreasing the viscosity of the increased viscosity treatment fluid.
